(19) United States
(12) Patent Application Publication
(10) Pub. No.: US 2014/0337378 A1
(43) Pub. Date: Nov. 13, 2014

(54) MOVABLE CLOUD SERVER AND CLOUD SYSTEM AND METHOD FOR QUICKLY READING DATA

(71) Applicant: HON HAI PRECISION INDUSTRY CO., LTD., New Taipei (TW)

(72) Inventor: CHAO-TSUNG FAN, New Taipei (TW)

(73) Assignee: HON HAI PRECISION INDUSTRY CO., LTD., New Taipei (TW)

(21) Appl. No.: 14/270,482

(22) Filed: May 6, 2014

(30) Foreign Application Priority Data
May 7, 2013 (TW) 102116232

(51) Int. Cl. G06F 17/30

(52) U.S. Cl. CPC G06F 17/30545
USPC 707/770

(57) ABSTRACT

A movable server is provided. The movable server can include a storage unit to store information database, a searching module to search the information database according to a search request containing search criteria transmitted from a terminal and determine whether there is data in the information database matching the search criteria, a request forwarding module to transmit the search request to a main server when no data in the information database matches the search criteria, and a storing and transmitting module to transmit the information matching the search criteria to the terminal when there is data in the information database matching the search criteria and further to cache the data transmitted from the main server and relay the data to the terminal when there is no data matching the search criteria in the information database. A cloud system and a method for quickly reading data are also provided.

### FIELD

The present disclosure relates to cloud server technology, and more specifically to a movable cloud server and a cloud system and a method for quickly reading data of the cloud system.

### BACKGROUND

Cloud systems include a number of servers which can be located anywhere to provide services to electronic devices in other locations. However, each server may only store a limited amount of data. In addition, if there is too much data to be processed, the main server may not be able to process the data quickly.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts or sections throughout the drawings.

FIG. 1 illustrates an application environment of a cloud system in accordance with an embodiment.

FIG. 2 is a block diagram of the cloud system of FIG. 1 in accordance with the embodiment.

FIG. 3 is a flowchart of an embodiment of a method for quickly reading data in accordance with the embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one”. The references “a plurality of” and “a number of” mean “at least two.”

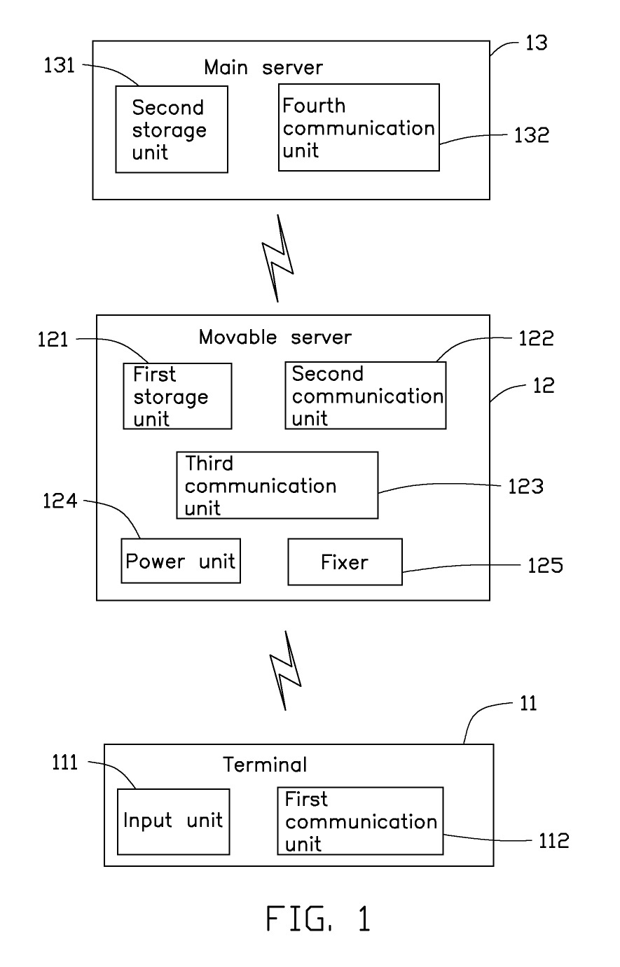

FIG. 1 illustrates an application environment of a cloud system in accordance with an embodiment. The cloud system has a number of function modules which are applied on a terminal 11, a movable server 12 or a main server 13.

The terminal 11 can include an input unit 111 and a first communication unit 112. The input unit 111 is used for generating input signals in response to user's operations applied thereon.

The movable server 12 can include a first storage unit 121, a second communication unit 122, a third communication unit 123, a power unit 124, and a fixer 125. The first storage unit 121 is a buffer memory, which is used for storing an information database. In this embodiment, the movable server 12 is received in a hot air balloon. The hot air balloon is balloon for travel through the air in a basket suspended below a large bag of heated air. The power unit 124 provides power to the hot air balloon so that the hot air balloon can rise up. The fixer 125 controls the hot air balloon to keep at a predetermined height.

The main server 13 can include a second storage unit 131 and a fourth communication unit 132. The second storage unit 131 stores an information database.

The terminal 11 is able to wirelessly communicate with the movable server 12 via the first communication unit 112. The movable server 12 is able to wirelessly communicate with the main server 13 via the third communication unit 123.

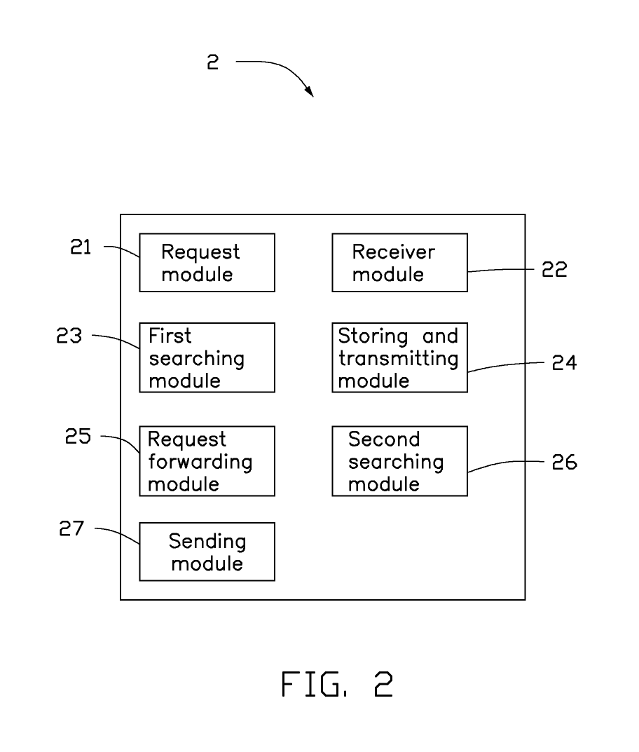

FIG. 2 illustrates a block diagram of the cloud system 2 of FIG. 1 in accordance with the embodiment. The function modules of the cloud system 2 can include a request module 21, and a receiver module 22 which are run on the terminal 11. The function modules of the cloud system 2 can further include a first searching module 23, a storing and transmitting module 24, and a request forwarding module 25 which are run on the movable server 12. The function modules of the cloud system 2 can further include a second searching module 26 and a sending module 27 which are run on the main server 13. In other embodiment, the function modules of the cloud system 2 are collection of software instructions, and executed by the terminal 11, or the movable server 12, or the main server 13.

The request module 21 is used for controlling the terminal 11 to generate a search request containing search criteria in response to a user's operation applied on the input unit 111 and controlling the first communication unit 112 of the terminal 11 to transmit the search request to the movable server 12.

The first searching module 23 is used for controlling the movable server 12 to search the information database storing in the first storage unit 121 of the movable server 12 according to the search request and determine whether there is data in the information database of the movable server 12 matching the search criteria of the search request.

The storing and transmitting module 24 is used for controlling the second communication unit 122 to transmit the data storing in the first storage unit 121 matching the search criteria of the search request to the terminal 11 when there is data in the information database of the movable server 12 matching the search criteria of the search request.

The receiver module 22 is used for controlling the first communication unit 112 of the terminal 11 to receive the data matching the search criteria of the search request.

The request forwarding module 25 is used for controlling the third communication unit 123 to transmit the search request to the server 13 when there is no data in the information database of the movable server 12 matching the search criteria of the search request.

The second searching module 26 is used for controlling the server 13 to search the information database of the second storage unit 131 according to the search request and determine whether there is data in the information database of the second storage unit 131 matching the search criteria of the search request.

The sending module 27 is used for controlling the fourth communication unit 132 to transmit the data storing in the second storage unit 131 matching the search criteria of the search request to the movable server 12 when there is data stored in the information database of the second storage unit 131 matching the search criteria of the search request.

The storing and transmitting module 24 is used for controlling the second storage unit 131 to storing the information which is storing in the second storage unit 131 matching the search criteria of the search request transmitted from the main server 13 and further controlling the second communication unit 122 of the movable server 12 to transmit the data storing in the second storage unit 131 matching the search criteria of the search request to the terminal 11.

The receiver module 22 is used for controlling the first communication unit 112 of the terminal 11 to receive the data which is storing in the second storage unit 131 matching the search criteria of the search request.

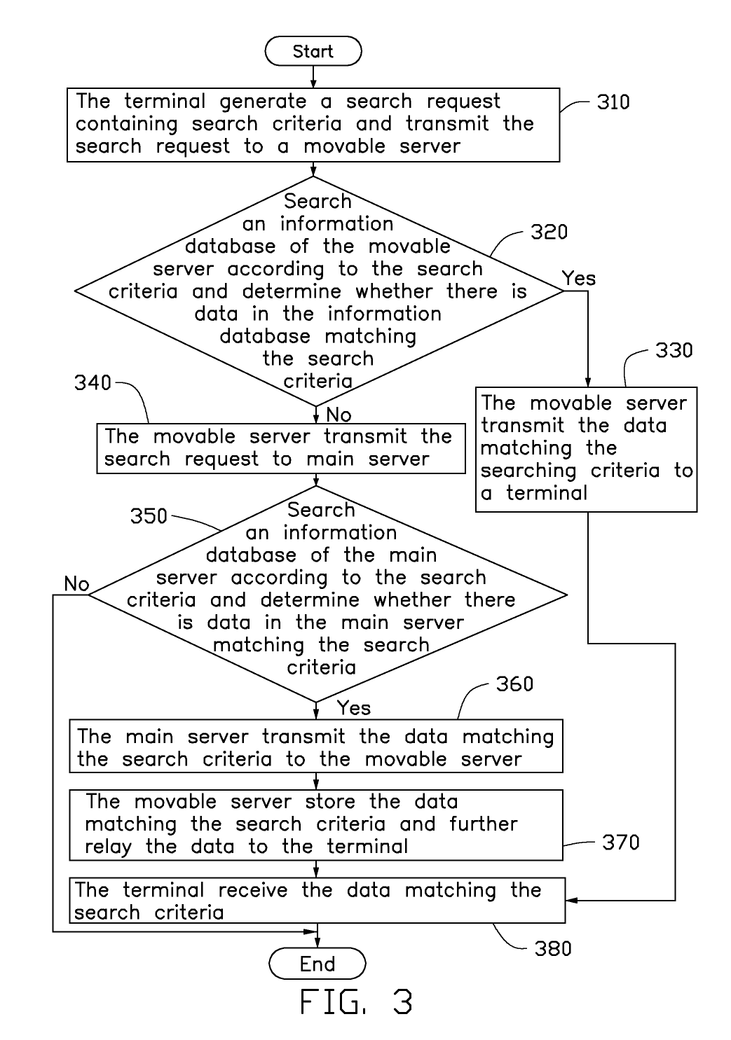

FIG. 3 is a flowchart of an embodiment of a method for quickly reading data in accordance with the embodiment.

In block 310, the request module controls the terminal to generate a search request containing search criteria in response to a user's operation applied on the input unit and controlling the first communication unit of the terminal to transmit the search request from the terminal to the movable server.

In block 320, the first searching module controls the movable server to search the information database stored in the first storage unit according to the search request and determine whether there is data in the information database of the first storage unit matching the search criteria of the search request, if yes, the process goes to 330, otherwise, the process goes to 340.

In block 330, the storing and transmitting module control the second communication unit to transmit the data matching the search criteria of the search request from the movable server to the terminal, and then the process goes to 380.

In block 340, the request forwarding module controls the third communication unit to transmit the search request from the movable server to the main server.

In block 350, the second searching module controls the main server to search the information database storing in the second storage unit of the main server and determine whether there is data in the information database of the second storage unit matching the search criteria of the search request, if yes, the process goes to block 360, otherwise, the process goes to end.

In block 360, the sending module controls the fourth communication unit to transmit the data matching the search criteria of the search request from the main server to the movable server.

In block 370, the storing and transmitting module controls the second storage unit of the movable server to store the data which is storing in the second storage unit matching the search criteria of the search request and further controls the second communication unit of the movable server to transmit the data matching the search criteria of the search request to the terminal.

In block 380, the receiver module controls the first communication unit of the terminal to receive the data matching the search criteria of the search request.

Although the present disclosure has been specifically described on the basis of various embodiments thereof, the disclosure is not to be construed as being limited thereto. Various changes or modifications may be made to the embodiments without departing from the scope and spirit of the disclosure.

What is claimed is:

1. A movable server, comprising:
a storage unit storing an information database;
a searching module to search data from the information database according to a search request and to determine whether there is data stored in the information database that matches the search criteria, wherein the search request containing a search criteria transmitted from a terminal;
a request forwarding module to transmit the search request to a main server when no data in the information database matches the search criteria;
a storing and transmitting module to transmit the data matching the search criteria to the terminal when there is data in the information database matching the search criteria of the search request and further to cache the data stored in the main server matching the search criteria transmitted from the main server and relay the data transmitted from the main server to the terminal when no data in the information database matches the search criteria.

2. The movable server as described in claim 1, further comprising a power unit and a fixer, wherein the movable server is received in a fire balloon, the power unit provides power to the fire balloon for rising up and the fixer control the fire balloon to keep at a predetermined height.

3. A cloud system, comprising a plurality of modules executable by a terminal, a movable server, or a main server, the plurality of modules comprising:
a request module to control the terminal to generate a search request containing search criteria and transmit the search request to the movable server;
a first searching module to control the movable server to search data from an information database storing in the movable server according to the search request wherein the search request containing a search criteria transmitted from a terminal and determine whether there is data in the information database matches the search criteria of the search request;
a request forwarding module to transmit the search request from the movable server to the main server when no data in the information database of the movable server matches the search criteria of the search request;
a second searching module to control the main server to search information database storing in the main server according to the search request and determine whether there is data in the information database of the main server matches the search criteria of the search request;
a sending module to transmit the data stored in the main server matching the search criteria of the search request from the main server to the movable server;
a storing and transmitting module to transmit the data of the movable server matching the search criteria of the search request from the movable server to the terminal when no data in the information database of the movable server matches the search criteria of the search request and further to store the data of the main server matching the search criteria of the search request transmitted from the main server to the movable server and relay the data transmitted from the main server to the terminal.

4. The cloud system as described in claim 3, the request module is run on the terminal, the first searching module, the storing and transmitting module, and the request forwarding module are run on the movable server; the second searching module and the sending module are run on the main server.

5. The cloud system as described in claim 3, the request module is a collection of software instructions, and executed by the terminal, the first searching module, the storing and transmitting module, and the request forwarding module are collection of software instructions, and executed by the movable server; the second searching module and the sending module are collection of software instructions, and executed by the main server.

6. A method for quickly reading information, comprising:
searching information database of a movable server according to a search request, wherein the search request containing a search criteria transmitted from a terminal and determine whether there is data storing in the movable server matching the search criteria of the search request;
transmitting the data in the information database of the movable server matching the search criteria of the search request from the movable server to a terminal when there is data stored the information database of the movable server matches the search criteria of the search request;
transmitting the search request from the movable server to a main server when there is no data in the information database of the movable server matching the search criteria of the search request;
storing the data of the main server matching the search criteria of the search request transmitted from the main server to the movable server and relay the data to the terminal.
